(19) United States
(12) Patent Application Publication
(10) Pub. No.: US 2012/0147040 A1
(43) Pub. Date: Jun. 14, 2012

(54) APPARATUS AND METHOD FOR PROVIDING WIRELESS NETWORK INFORMATION

(75) Inventor: Sam-Souk YUN, Goyang-si (KR)

(73) Assignee: PANTECH CO., LTD., Seoul (KR)

(21) Appl. No.: 13/197,541

(22) Filed: Aug. 3, 2011

(30) Foreign Application Priority Data
Dec. 14, 2010 (KR) 10-2010-0127686

(51) Int. Cl. G09G 5/12

(52) U.S. Cl. 345/633

(57) ABSTRACT

In a terminal to display wireless network information by use of augmented reality, the terminal is able to be connected to various servers that provide wireless network information through a communication network. In a method for displaying wireless network information using augmented reality, a real-world image is acquired. Wireless network information for a region, corresponding to a location of the image, is acquired from the server. The acquired wireless network information is overlaid onto the real-world image and displayed.

### CROSS-REFERENCE TO RELATED APPLICATION

This application claims priority from and the benefit under 35 U.S.C. §119(a) of Korean Patent Application No. 10-2010-0127686, filed on Dec. 14, 2010, which is incorporated by reference for all purposes as if fully set forth herein.

### BACKGROUND

1. Field

The following description relates to an augmented reality apparatus and method, and more particularly, to an apparatus and method for providing wireless network information in an augmented reality based display.

2. Discussion of the Background

Augmented reality (AR) is a computer graphic scheme that allows a virtual object or information to be seen as if the virtual object or information exists in a real-world environment by combining the virtual object or information with an image of the real-world environment.

Unlike virtual reality, which displays only virtual spaces, the AR provides additional information that is not obtainable based on a view of the real-world, by adding a virtual object and/or information to the view of the real-world. Thus, AR is applicable to various fields and applications using real-world environments.

### SUMMARY

Exemplary embodiments of the present invention provide an apparatus and method for providing wireless network information by use of augmented reality information.

Additional features of the invention will be set forth in the description which follows, and in part will be apparent from the description, or may be learned by practice of the invention.

An exemplary embodiment provides a method for providing wireless network information, the method including acquiring a real-world image; acquiring wireless network information based on a surrounding of a location of the real-world image; and outputting the acquired wireless network information overlaid onto the real-world image.

An exemplary embodiment provides an apparatus to display wireless network information, the apparatus including an image acquiring unit to obtain a real-world image; a display unit to output the real-world image; a communication unit to process signals which are is transmitted and received to/from various servers that provide wireless network information; and a control unit to obtain wireless network information based on the location of the real-world image, wherein the display unit displays the wireless network information onto the real-world image.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows an augmented reality system to provide wireless network information according to an exemplary embodiment.

FIG. 2 shows the internal configuration of a terminal according to an exemplary embodiment.

FIG. 3 shows an interface screen that is obtained by overlapping wireless network information with augmented reality information according to an exemplary embodiment.

FIG. 4 shows wireless network information viewed on a map according to an exemplary embodiment.

FIG. 5 shows filtered wireless network information viewed on a map according to is an exemplary embodiment.

FIG. 6 shows the internal configuration of a server according to an exemplary embodiment.

FIG. 7 shows control flow of a method for providing wireless network information by use of augmented reality information according to an exemplary embodiment.

FIG. 8 shows control flow of a method for registering wireless network information according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art.

Hereinafter, examples will be described with reference to accompanying drawings in detail.

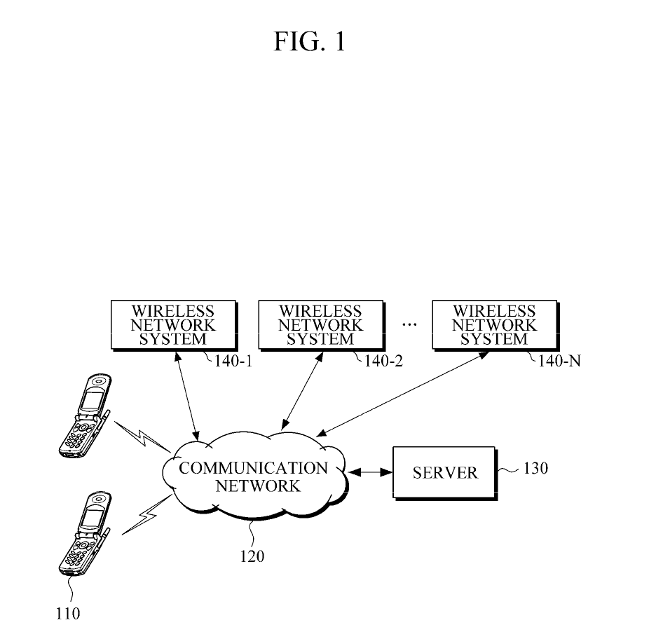

FIG. 1 shows an augmented reality system to provide wireless network information according to an exemplary embodiment.

Referring to FIG. 1, an augmented reality system may include at least one terminal 110 and a wireless network information providing server (hereinafter, referred to as a “server”) 130, the server 130 being configured to provide the terminal 110 with information that may be used for providing an augmented reality service. The terminal 110 and the server 130 may be connectable to at least one wireless network system 140 including wireless network systems 140-1, 140-2, . . . and 140-N, through a communication network 120.

The wireless network system 140 may represent a system configured to provide the terminal 110 with a wireless internet service. The wireless network system 140 may be represented with one or more types of networks, such as a 3G network, a Wireless broadband (Wibro), a World Interoperability for Microwave Access (Wimax), High Speed Downlink Packet Access (HSDPA), Wireless LAN, such as Wi-Fi, and Long term Evolution (LTE), and the like.

The terminal 110 may be a mobile communication terminal, such as a mobile phone, a smart phone, a personal digital assistant (PDA), and a navigation terminal. The terminal 110 may be a personal computer, such as a desktop computer and a notebook. The terminal 110 may be implemented as a device that can trace its current position, send the traced position to the server 130 and display augmented reality data based on the current position and information from the server 130. The augmented reality view may be generated by overlaying wireless network information of a surrounding space onto a real-world image. The surrounding space may correspond to a requested space based on a search. In addition, the terminal 110 may be implemented using a terminal connected to a single wireless network to achieve a voice call service or internet service, or a multi-mode terminal which is selectively connectable to one or to two or more wireless networks systems 140-1, 140-2, . . . and 140-N. The server 130 collects/registers at least one piece of information about at least one of the wireless network is systems 140-1, 140-2, . . . and 140-N and provides the terminal 110 with the information about the wireless networks systems 140-1, 140-2, . . . and 140-N that have been registered.

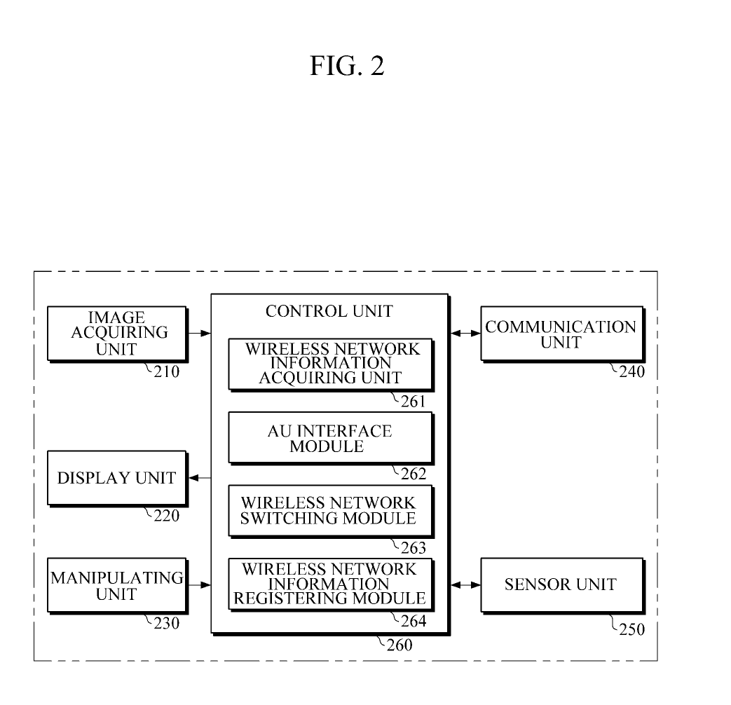

FIG. 2 shows the internal configuration of a terminal according to an exemplary embodiment.

Referring to FIG. 2, an image acquiring unit 210 is configured to acquire an image, which may be of the real world, and output the acquired image to a control unit 260. This process may be implemented using a camera or another technique involving image acquisition, such as acquiring an image file. The image acquiring unit 210 processes an image frame of a still image or a video, acquired by an image sensor. The image acquiring unit 210 may be implemented using a camera or device that can enlarge or reduce an image according to the control operation of the control unit 260, and/or a camera or device that can rotate the image in a manual or automatic manner.

The display unit 220 is configured to display an image, such as an image of the outside environment, and may be implemented using a panel, for example, a liquid crystal display (LCD) that can display an image or texts. In addition, the display unit 220 may be provided in the form of a built-in part of a terminal, or provided in the form of an external part that can be connected to a terminal through an interface such as a universal serial bus (USB) port. The display unit 220 outputs information that is processed in the terminal, and may display a User Interface (UI) or a graphic user interface (GUI) related to a control operation. In addition, in the case that a sensor configured to sense a touch forms an interactive layer structure, the display unit 220 may serve as a manipulating unit 230.

A manipulating unit 230 corresponding to a user interface receives information. For example, the manipulating unit 230 may include a key input part, which generates key is information if a key button is pushed, a touch sensor and/or a mouse.

A communication unit 240 processes signals that are received from the outside through a communication network 120 and outputs the processed signals. In addition, the communication unit 240 may process signals received from the control unit 260 and transmit the processed signals through the communication network 120.

A sensor unit 250 may sense various attributes/data, including the location of a terminal in real time, the photographing direction of a terminal, the change in the location of a terminal, and the speed in change of the photographing direction. The sensor unit 250 may output the sensed data to the control unit 260. The sensor unit 250 may include a global positioning system (GPS) receiver to receive a location information signal of a terminal that is sent from a GPS satellite, a gyro sensor to sense the azimuth, the azimuth angle and the tilt angle of a terminal, an accelerometer that measures the rotation direction and the amount of rotation of a terminal and generates sensing signals.

Although not shown in drawings, the terminal 110 may further include an identification module corresponding to a chip that stores various types of information used to grant a wireless network accessing rights. The identification module may include one or more of a User Interface Module (UIM), a Subscriber Identify Module (SIM), and a Universal Identity Module (USIM). If the terminal 110 is implemented using a multimode terminal, the terminal 110 may include at least two identification modules.

The control unit 260 controls the above-described components of the terminal 110, to acquire wireless network information of a surrounding space of the terminal 110, and provides augmented reality data by overlaying the acquired network information. The control unit 260 may be a hardware processor or a software processor implemented on a hardware processor. The control unit 260 may include a wireless network information acquiring unit 261, an augmented reality interface module 262, a wireless network switching module 263 and a wireless network information registering module 264.

The wireless network information acquiring unit 261 acquires wireless network information of a surrounding space of the terminal 110 by connecting to the server 130 with the communication unit 240. The wireless network information acquiring unit 261 sends the server 130 a request message for wireless network information. The request message for wireless network information includes location information about a location of an image acquired with the sensor unit 250. The image may be of a real-world location. The location of the image may represent a specified location, or a location ascertained from a moving path from a current location of the terminal traced by the sensor unit 250.

In addition, the wireless network information acquiring unit 261 receives wireless network information from the server 130 as a response to the request message. The wireless network information may include at least one of the type of wireless network existing or detected in the surrounding space of the location of the image, the coordinates of a wireless network relay, the distance between the location of the image and the wireless network relay, the network provider information and the signal level information for each wireless network. The augmented reality interface module 262 overlays the acquired wireless network information onto the image of the real world, and outputs the acquired wireless network information overlaid onto the real-world image to the display unit 220, thereby providing an augmented reality interface.

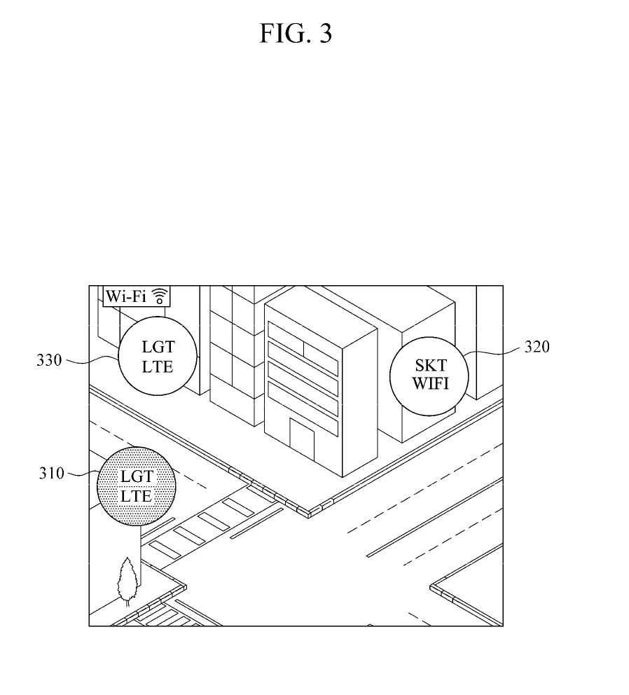

FIG. 3 shows an interface screen that is obtained by overlapping wireless network information with augmented reality information according to an exemplary embodiment.

In FIG. 3, the location of two long term evolution (LTE) wireless networks of a is Lucky Goldstar Telecom (LGT) provider, represented as augmented reality information 310 and 330, and the location of a WIFI wireless network of a Sun Kyung Telecom (SKT) provider, represented as augmented reality information 320, are displayed in conjunction with a real time image of a location, thereby evidencing the existence of a wireless network in the surrounding space. The augmented reality interface module 262 displays the signal level information of each wireless network in addition to the distribution of each wireless network. Referring to FIG. 3, a wireless network having a stronger electric field is displayed as being darker, such as augmented reality information 310, and a wireless network having a weak electric field is displayed as being lighter, such as augmented reality information 320 and 330. The method of indicating the signal level is not limited thereto, and may be implemented in various schemes, for example, a larger displayed size may represent a stronger electric field. In addition, if the terminal 110 is at an indoor location, the augmented reality interface module 262 may display wireless network information available only at the indoor location or within a defined geographical region.

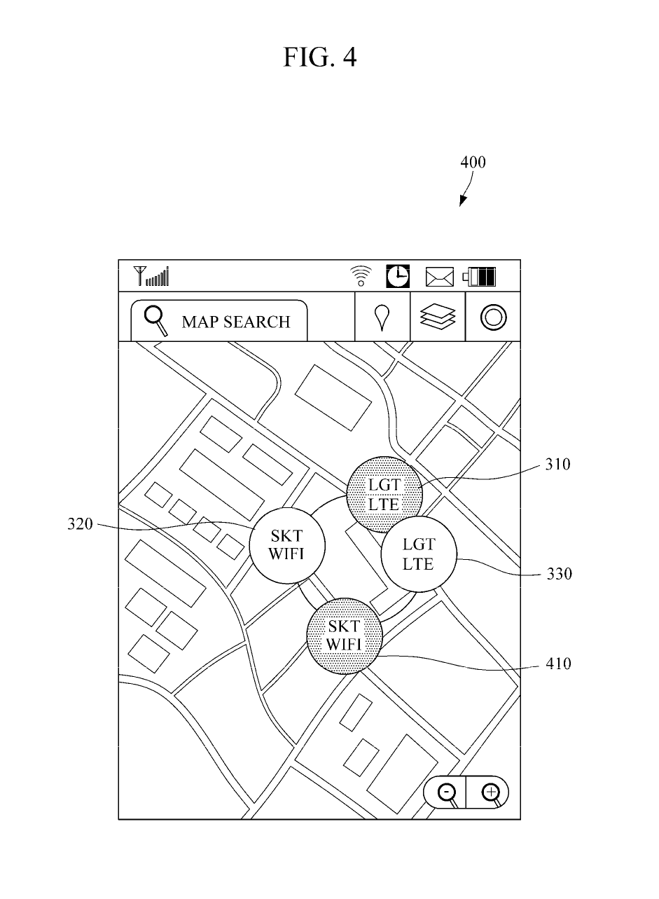

FIG. 4 shows wireless network information viewed on a map according to an exemplary embodiment.

Referring to FIG. 4, the augmented reality interface module 262 outputs a two-dimensional map 400 having the wireless network information displayed thereon upon reception of a request for map information via the manipulating unit 230. The map information may be displayed on the entire screen or on a part of the screen.

Again, referring to FIG. 4, the location of a LTE wireless networks of a LGT provider, represented by augmented reality information 310 and 330, and the location of a WI-FI wireless networks of a SKT provider, represented by augmented reality information 320 and 410, are shown as wireless network information on a two-dimensional map 400. In addition, the is signal level information of each wireless network is distinguishably indicated. For example, a darker circle may represent stronger signal strength than a lighter circle.

If the amount of wireless network information acquired by the terminal exceeds a specified amount of connections, the augmented reality interface module 261 may allow the display 220 to display some of the wireless network information by filtering the wireless network information based on a specified criteria.

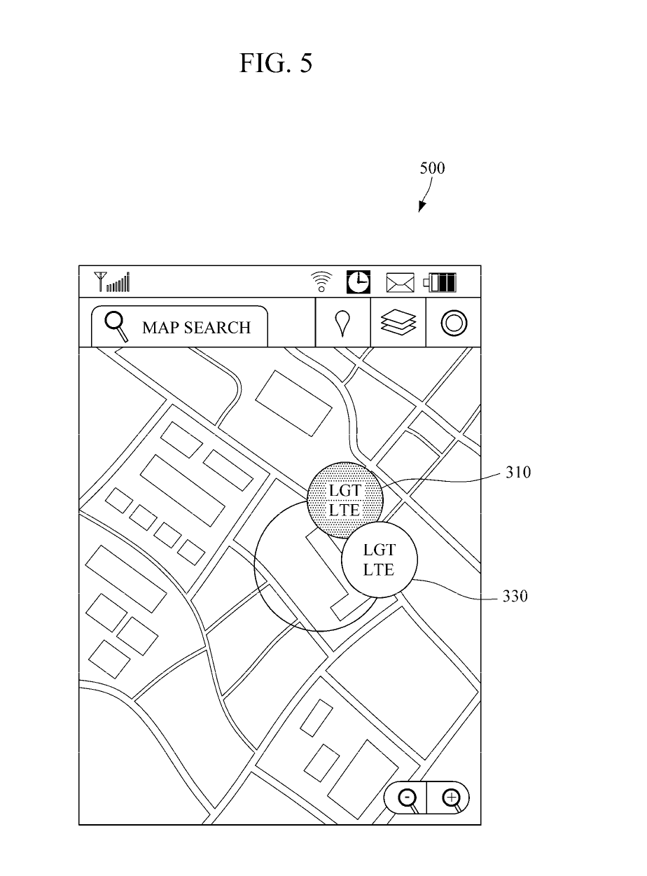

FIG. 5 shows filtered wireless network information viewed on a map according to an exemplary embodiment.

Referring to FIG. 5, a the two-dimensional map 400 shown in FIG. 4 differs from the two-dimensional map 500 shown in FIG. 5, because a filter is set to display only wireless networks of an LTE type. Thus, the two-dimensional map 500 shows augmented reality information 310 and 330, associated with LTE wireless network information of the LGT provider, and not the WI-FI wireless network information associated with the SKT provider.

Upon reception of a request for connection to a wireless network, the wireless network switching module 263 may switch a connection to the wireless network. Then, an authentication process for the selected wireless network is performed, thus causing a series of data transfers to be performed between the terminal and the selected wireless network to determine whether the terminal is able to connect to the selected wireless network. Through the data transfer, if it is determined that the terminal is connectable to the selected wireless network, the terminal connects to the wireless network.

Referring again to FIG. 2, the wireless network information registering module 264 acquires a signal level of a wireless network through the communication unit 240 and registers the acquired signal level in the server 130. For example, if the difference between a is signal level of a currently connected wireless network and a signal level included in the wireless network information exceeds a threshold value, the wireless network registering module 264 allows the signal level of the currently connected wireless network to be automatically registered in the server 130. In another example, the wireless network registering module 264 may transfer registration information to the server 130 via the manipulation unit 230.

Detailed operations of the control unit 260 will be further disclosed below with the description of an augmented reality providing method.

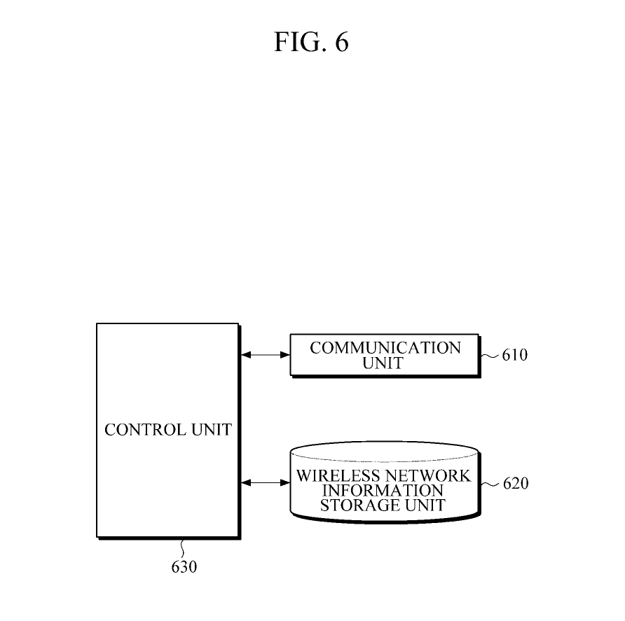

FIG. 6 shows the internal configuration of a server according to an exemplary embodiment.

Referring to FIG. 6, the server, which may correspond to a server 130 shown in FIG. 1, includes a communication unit 610, a wireless network information storage unit 620, and a control unit 630. The communication unit 610 processes signals, which are received from the communication network 120, and outputs the processed signals to the control unit 630.

The wireless network information storage unit 620 contains a database of wireless network information, each acquired from the terminal 110 or the wireless network systems 140-1, 140-2, . . . , 140-N through a communication network 120. The control unit 630 controls the operations of the above described components of server 130 (see FIG. 1) to acquire and store the wireless network information and provides the stored wireless network information to at least one terminal. The control unit 630 may be a hardware processor or a software processor implementable on a hardware processor.

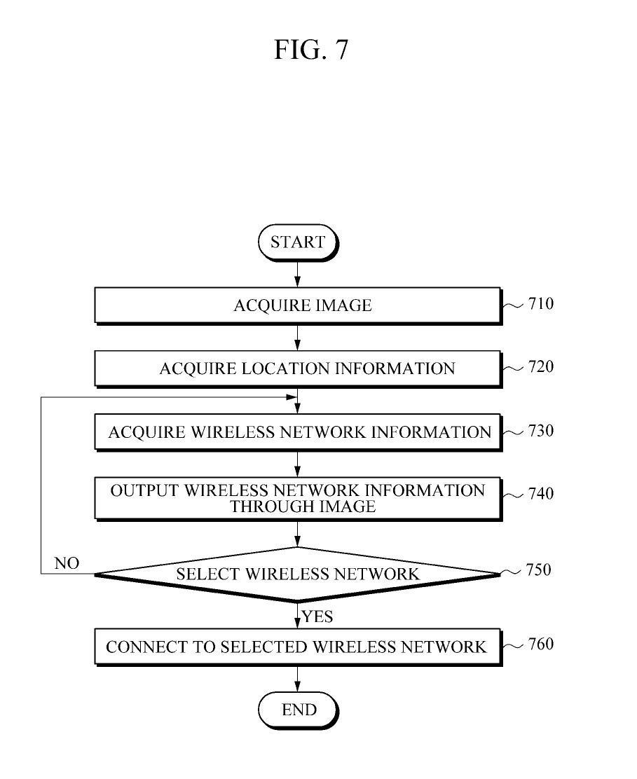

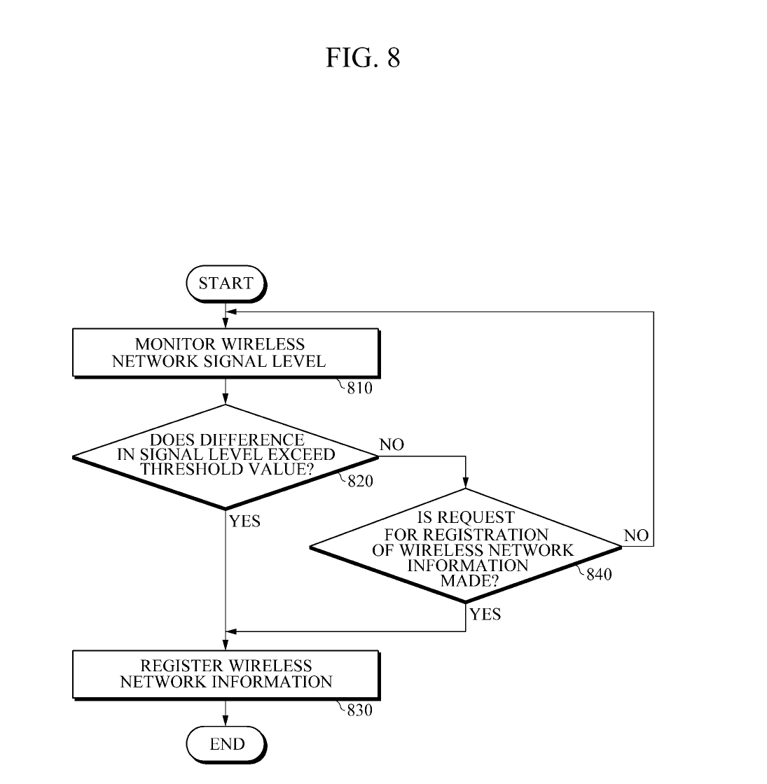

Hereinafter, a method for providing wireless network information by use of augmented reality in the above described system will be described with reference to FIG. 7 and FIG. 8.

FIG. 7 shows control flow of a method for providing wireless network information by use of augmented reality information according to an exemplary embodiment.

Referring to FIG. 7, the terminal outputs an image of the real-world that is acquired by operating the camera 210 via the manipulating unit 230 (710). The terminal acquires the location information of the terminal (720). The location information may include a specified location or the current location of the terminal acquired by the sensor unit 250. The “current location” may refer to a location corresponding to a time when the camera 210 is operated to capture the real-world image.

The terminal sends the server 130 a request message for wireless network information including the location information, and acquires wireless network information in response to the request message (730).

The wireless network information received from the server 130 for each wireless network may include at least one of the types of wireless network existing in the surrounding space of the location, the coordinates of a wireless network relay, the distance between the location of the image and the wireless network relay, the network provider information and the signal level information.

The terminal outputs the acquired wireless network information to correspond to a corresponding location and a corresponding direction of an image (740), in which the image may be a real-time image taken by the camera 210. In outputting the wireless network information, the terminal may indicate the signal level of each wireless network. For example, the terminal displays a wireless network having a stronger electric field to be darker, and a wireless network having a weaker electric field to be lighter. Upon a request, the terminal may output two-dimensional map information having the wireless network information displayed thereon. In addition, the terminal may display only some of the wireless network information through filtering based on specified, default, or preset criteria.

The terminal may determine whether to select the acquired wireless network information (750).

If the result of determination is that the wireless network is selected, the terminal connects to the wireless network (760). In this case, the terminal performs an authentication process for access to the selected wireless network. If the result of determination is that the wireless network is not selected, the terminal does not connect to a wireless network and instead performs an early operation, such as operation 710, operation 720, or operation 730 as shown in FIG. 7.

FIG. 8 shows control flow of a method for registering wireless network information according to an exemplary embodiment.

Referring to FIG. 8, the terminal monitors a wireless network signal of a currently connected wireless network (810). The terminal determines if the difference between a signal level that is detected in the terminal and a signal level included in the wireless network information exceeds a threshold value (820). The threshold value may be predetermined, may be a reference value, or may be set by a user.

If the result of the determination in operation 820 is that the difference between the signal level detected in the terminal and the signal level included in the wireless network information exceeds the threshold value, the terminal automatically registers the signal level information detected in the terminal in the server (830).

If the result of the determination in operation 820 is that the difference between the signal level detected in the terminal and the signal level included in the wireless network is information does not exceed the threshold value, the terminal determines whether a request signal for registration of wireless network information is input (840).

If the result of the determination in operation 840 is that the request signal for registration of wireless network information is input, the terminal proceeds to operation 830 and sends the server the wireless network information.

If the result of the determination in operation 840 is that the request signal for registration of wireless network information is not input, the terminal proceeds to operation 810 and monitors the wireless network signals.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for providing wireless network information, comprising:
acquiring a real-world image;
acquiring wireless network information for a region corresponding to a location of the real-world image; and
displaying the acquired wireless network information overlaid onto the real-world image.

2. The method of claim 1, wherein the wireless network information comprises at least one of: a type of a wireless network, coordinates of a wireless network relay, a distance between the location of the real-world image and the wireless network relay, network provider information, and signal level information for the wireless network.

3. The method of claim 1, wherein displaying comprises:
displaying a two-dimensional map information of the location and the acquired wireless network information.

4. The method of claim 1, wherein displaying comprises:
displaying the acquired wireless network information to be visibly distinguishable according to a signal level of each wireless network included in the wireless network information.

5. The method of claim 1, wherein displaying the acquired wireless network information further comprises:
filtering the acquired wireless network information according to a filter criteria; and
displaying the filtered wireless network information.

6. The method of claim 1, further comprising
if a difference between a signal level of a currently connected wireless network and a signal level included in the wireless network information exceeds a threshold value, transferring the signal level of the currently connected wireless network to a server.

7. The method of claim 1, further comprising connecting to a wireless network included in the acquired wireless network information.

8. An apparatus to display wireless network information, the apparatus comprising:
an image acquiring unit to obtain a real-world image;
a display unit to display the real-world image;
a communication unit to transmit and receive wireless signals to and from a server; and
a control unit to obtain wireless network information for a region corresponding to a location of the real-world image,
wherein the display unit displays the wireless network information overlaid on the real-world image.

9. The apparatus of claim 8, wherein the wireless network information comprises at least one of: a type of wireless network, coordinates of a wireless network relay, a distance between the location of the real-world image and the wireless network relay, network provider information, and signal level information for each wireless network.

10. The apparatus of claim 8, further comprising
a manipulating unit to receive an input,
wherein the control unit outputs two-dimensional map information having the wireless network information displayed thereon based on a received input.

11. The apparatus of claim 8, wherein the display unit displays the wireless network information according to visibly distinguishable signal levels of each wireless network of the wireless network information.

12. The apparatus of claim 8, wherein the control unit filters the wireless network information according to a filter criteria, and the display unit displays the filtered wireless network information.

13. The apparatus of claim 8, wherein, if a difference between a signal level of a currently connected wireless network and a signal level included in the wireless network information exceeds a threshold value, the control unit transfers the signal level of the currently connected wireless network to the server.

14. The apparatus of claim 8, wherein the control unit connects to a wireless network of the wireless network information, the input corresponds to the wireless network.

15. The method of claim 5, wherein the filter criteria is a type of wireless network or a type of wireless network provider.

16. The method of claim 5, wherein the filter criteria is signal strength.
